(19) United States
(12) Patent Application Publication
(10) Pub. No.: US 2023/0383060 A1
(43) Pub. Date: Nov. 30, 2023

(54) CONTINUOUS PROCESS FOR THE POLYMERIZATION OR OLIGOMERIZATION OF DIPHENYLAMINES

(71) Applicant: NYCO, PARIS (FR)

(72) Inventors: Yves TRAVERT, ERAGNY SUR OISE (FR); Grégoire HERVE, PARIS (FR)

(21) Appl. No.: 18/248,027

(22) PCT Filed: Oct. 6, 2021
(86) PCT No.: PCT/EP2021/077622

§ 371 Date: Apr. 5, 2023

(30) Foreign Application Priority Data
Oct. 6, 2020 (FR) FR2010199

(51) Int. Cl. C08G 73/02; C10M 149/22

(52) U.S. Cl. CPC C08G 73/026; C10M 149/22; C10M 2215/065; C10N 2030/10

(57) ABSTRACT

Disclosed is an at least partially continuous process for the preparation of at least one oligomer and/or polymer comprising at least one diphenylamine repeat unit and optionally at least one phenyl α-naphthylamine repeat unit.

### TECHNICAL FIELD

The present invention relates to the technical field of polymeric antioxidants which are used in lubricants. In particular, it relates to the solvent-free manufacture of antioxidants which are oligomers or polymers of at least one diphenylamine and optionally at least one phenyl α-naphthylamine.

### TECHNOLOGICAL BACKGROUND

Antioxidants based on diphenylamine and/or naphthylamine are well known and widely used in the field of lubricants. In particular, they may be used in monomeric form, in standard-performance lubricants, but antioxidants based on diphenylamine and/or naphthylamine in oligomeric or polymeric form have been developed for use thereof in high-performance lubricants.

In the aforementioned field, different processes have already been described in the prior art for synthesising oligomers or polymers of at least one diphenylamine and optionally at least one phenyl α-naphthylamine.

Thus, the patent applications US 2019/0127526, EP 0 734 432, EP 0 799 289, FR 2 832 417, EP 2 217 687, WO 2008/022028, U.S. Pat. No. 3,494,233 and WO 95/17488 describe processes for the preparation of oligomers or polymers comprising at least one diphenylamine and/or phenyl α-naphthylamine repeat unit.

For example, the document EP 0 734 432 describes a process for the discontinuous preparation of an antioxidant stabiliser composition which is the product of the reaction between an N-aryl-naphthylamine, a diphenylamine, an organic peroxide and a solvent. The reaction is implemented in a distillation column. The obtained composition has a brown colour (Example 2).

All these processes are discontinuous processes, also referred to by the terms “batch”, i.e. the process is implemented in a closed reactor, in which the reagents are introduced, the polymerisation reaction is completed, then at the end of the reaction the products are isolated from the reaction medium.

Batch type reactors and continuous reactors are substantially different, for technical reasons and for practical reasons. On the technical level, for exothermic reactions for example, the size of the discontinuous reactor might be limited by the heat transfer. In large-capacity reactors, it is often necessary to dilute the reagents by adding solvent to be able to control the exothermicity of the reaction or to limit the size of the reactor. On the practical level, a discontinuous process requires at the end of the reaction the depressurisation of the reactor, cooling thereof, opening thereof, and draining thereof to recover the reaction mixture under good safety conditions; these discontinuous operations are complex and labour intensive.

Some processes of the prior art also involve the use of at least one solvent to dilute the reagents. Whether the process is discontinuous or continuous, the use of solvents has drawbacks from an energy perspective, in particular in terms of cost of separation or heating of a larger mass, from an environmental perspective, in particular with regards to discharges, and from an economical perspective, in particular in terms of investment cost of the separation step, cost of the solvent and/or reduction in the reaction rates.

Finally, the implementation of discontinuous oligomerisation and/or polymerisation processes is often faced with difficulties in replicating the properties of the polymers or oligomers from one batch to another, in particular in terms of viscosity, colour, point flash, residual monomer content which could be related to a more or less significant variation of the polydispersity.

In the lubricant industry, in particular lubricants for the aeronautical and/or automotive industries, the colour of lubricants and additives is an important parameter, because a visually dark lubricant is often associated with a spent lubricant. Comparatively, a visually clear lubricant is often associated with a new lubricant. Consequently, the repeatability of the parameters of the oligomers and/or polymers influencing their colour from one synthesis to another is an important point that ought to be optimised.

### DISCLOSURE OF INVENTION

In this context, the Applicant has demonstrated that it is possible to prepare oligomers or polymers comprising at least one diphenylamine repeat unit and optionally at least one phenyl α-naphthylamine repeat unit using an at least partially continuous process, which has many advantages compared to the previously-described discontinuous processes.

### SUMMARY OF THE INVENTION

Thus, the present invention relates to a process for preparing at least one oligomer and/or polymer comprising at least one diphenylamine repeat unit and optionally at least one phenyl α-naphthylamine repeat unit, comprising the following steps:

(a) the introduction into a suitable reactor of:
at least one diphenylamine,
optionally at least one phenyl α-naphthylamine,
at least one organic peroxide, and
at least one ester lubricant;

(b) the polymerisation or oligomerisation of diphenylamine and optionally of phenyl α-naphthylamine to obtain a mixture comprising at least one oligomer or a polymer comprising at least one diphenylamine unit and optionally at least one phenyl α-naphthylamine unit, and

(c) subjecting the mixture obtained at step (b) to conditions suitable for reducing and/or eliminating at least part of the residual reagents and/or reaction by-products other than the oligomers or polymers comprising at least one diphenylamine unit and optionally at least one phenyl α-naphthylamine unit, wherein steps (a) and (b) are implemented continuously and wherein step (b) is carried out at a temperature equal to or higher than 170° C.

According to the invention, a temperature equal to or higher than 170° C. comprises the following values or any interval between these values: 170; 175; 180; 185; 190; 195; 200; 205; 210; 215; 220; 225; 230; 235; 240; 245; 250, etc.

In general, step (b) is carried out at a temperature ranging from 180° C. to 250° C., preferably ranging from 180° C. to 230° C.

According to one feature of the invention, the mixture obtained at step (b) comprises an unreacted peroxide content lower than or equal to 60%, preferably lower than or equal to 45% and typically lower than or equal to 40%, the peroxide content being determined by gas-phase chromatography.

According to another feature of the invention, the mixture obtained at step (b) comprises a residual monomer content lower than or equal to 25%, preferably lower than or equal to 10% and typically lower than or equal to 5%, the residual monomer content is a weight percentage determined by gas-phase (GC) and supercritical (SFC) chromatography.

Compared to the processes of the prior art, this process has in particular a reduced cycle time, an improvement in the quality of the obtained oligomer or polymer, in particular in terms of colour, a greatly reduced variability in the characteristics of the product such as its viscosity, polydispersity, its flash point, its colour and/or its residual monomer content, increased safety, environmental advantages, simplified maintenance, space saving and ease of use.

Of course, the different features, variants and embodiments of the invention can be associated with each other in various combinations to the extent that they are not incompatible or exclusive of each other.

For the rest of the description, unless stated otherwise, the indication of an interval of values “from X to Y” or “between X and Y”, in the present invention, should be understood as including the X and Y values.

### DETAILED DESCRIPTION

By “continuous”, reference is made in the present invention to the conventional meaning in the art. In particular, reference is made to an implementation of a process in which the supply of at least one of the reagents and/or the draw-off of all or part of the content of the reactor are performed continuously, preferably with an identical flow rate at the inlet and at the outlet of the reactor. Preferably, the process implemented continuously according to the invention is such that the control of the supplies, draw-off and the other polymerisation conditions ensures stationary operating conditions in the reactor.

In one embodiment, all of the steps of the process according to the invention are implemented continuously.

By “polymer” of at least one diphenylamine and optionally at least one phenyl α-naphthylamine, reference is made in the present invention to a compound comprising the repetition of at least two diphenylamine and/or phenyl α-naphthylamine units.

By “oligomer” of at least one diphenylamine and optionally at least one phenyl α-naphthylamine, reference is made in the present invention to a polymer of at least one diphenylamine and optionally at least one phenyl α-naphthylamine which comprises between 2 and 10 repeat units, or a mixture of such compounds. In particular, it may consist of a dimer, a trimer, a tetramer, a pentamer, a hexamer, a heptamer, an octamer, a nonamer, a decamer and/or any mixture of such compounds. Preferably, the oligomer contains at least 90% by weight of dimer, trimer, tetramer, pentamer or a mixture of such compounds.

Preferably, the proportion of residual monomer in the oligomer or polymer obtained upon completion of step (b) is lower than or equal to 10% by weight, in particular lower than or equal to 5% by weight.

By “diphenylamine”, reference is made to a compound of formula (I):

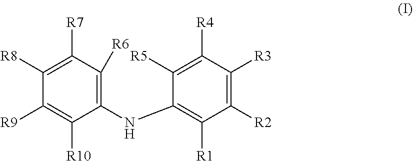

wherein each of R1 to R10 is independently selected from among a hydrogen atom, an alkyl group and an aralkyl group.

In one embodiment, the at least one diphenylamine of formula (I) is an alkylated diphenylamine, i.e. at least one amongst R1 to R10 is an alkyl or aralkyl group. In another embodiment, at least one amongst R1 to R5 is an alkyl or aralkyl group, and at least one amongst R6 to R10 is an alkyl or aralkyl group.

By “alkyl”, reference is made in the present invention to a linear, branched or cyclic saturated hydrocarbon group, comprising from 1 to 24 carbon atoms. Preferably, an alkyl group comprises from 1 to 12 carbon atoms. Among the alkyl groups, mention may in particular be made of the methyl group, the ethyl group, the n-propyl group, the iso-propyl group, the n-butyl group, the tert-butyl group, the iso-butyl group, the n-pentyl group, iso-pentyl group, n-hexyl group, cyclohexyl group, n-heptyl group, n-octyl group, tert-octyl group, iso-octyl group, n-nonyl group, n-decyl group, n-undecyl group, n-dodecyl group and iso-dodecyl group. In a particular embodiment, an alkyl group is selected from the group consisting of the tert-butyl group and the tert-octyl group.

By “aralkyl”, reference is made in the present invention to an alkyl group wherein at least one of the carbon atoms is substituted by an aryl group. Among examples of aralkyl groups, mention may in particular be made of the 1-methyl-1-phenylethyl group.

By “aryl group”, reference is made in the present invention to a hydrocarbon aromatic monocyclic or polycyclic group. Each aromatic or polyaromatic ring comprises 5 to 14 atoms. Among examples of aryl groups, mention may in particular be made of the phenyl group.

In one embodiment, the diphenylamine of formula (I) is selected from the group consisting of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine, N-(p-tert-butylphenyl)-N-(p-tert-octylphenyl)amine and any mixture thereof.

The diphenylamines according to the invention may be supplied isolated, or as a mixture with each other. For example, they may be in the form of a mixture of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, in particular the mixture known under the name Irganox® L57 and CAS number 68411-46-1.

By phenyl α-naphthylamine, reference is made according to the present invention to a compound of formula (II):

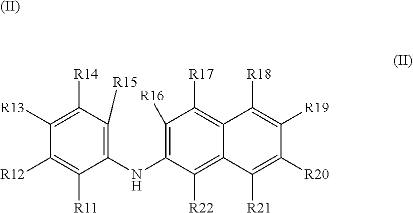

wherein each of R11 to R22 is independently selected from a hydrogen atom and an alkyl group.

In one embodiment, at least one amongst R11 to R22 is an alkyl group. In one embodiment, only one amongst R11 to R22 is an alkyl group, in particular a tert-octyl group.

In a particular embodiment, the phenyl α-naphthylamine is N-phenyl 1,1,3,3-tetramethylbutylnaphthalen 1-amine, with CAS number 68259-36-9.

In a particularly preferred embodiment, the at least one diphenylamine is in the form of a mixture of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, and the at least one phenyl α-naphthylamine is N-phenyl 1,1,3,3-tetramethylbutylnaphthalen 1-amine.

The relative proportions by weight of the two types of diphenylamine and phenyl α-naphthylamine units within the polymer or the oligomer may vary to a large extent from 0/100 to 100/0. Preferably, the diphenylamine/phenyl α-naphthylamine relative proportion by weight is comprised between 100/0 and 50/50, in particular comprised between 100/0 and 90/10, in particular comprised between 100/0 and 95/5. In a particular embodiment, the polymer or the oligomer obtained by the process according to the present invention comprises only diphenylamine units. A person skilled in the art is able to adjust the amounts of diphenylamine and of phenyl α-naphthylamine to be introduced into the reactor particular according to the desired structure of the oligomer or polymer to be synthesised and the desired thermal characteristics.

In one embodiment, step (a) is a step of introducing into a suitable reactor:
at least one diphenylamine,
at least one phenyl α-naphthylamine,
at least one organic peroxide, and
at least one ester lubricant.

In this embodiment, the polymers and/or oligomers obtained upon completion of the process according to the invention comprise diphenylamine repeat units and phenyl α-naphthylamine repeat units.

Of course, since steps (a) and (b) of the process according to the invention are implemented continuously, and lead to the continuous consumption of all or part of the reagents introduced into the reactor, all proportions and amounts of each of the reagents mentioned in the present application correspond to proportions and amounts at the time of introduction thereof into the reactor.

The at least one diphenylamine and/or the at least one phenyl α-naphthylamine may be introduced into the reactor either pure or diluted in at least one diluent.

By “diluent”, reference is made in the present invention to a compound that is not intended to be eliminated or separated from the polymer or from the oligomer obtained at the end of the reaction, in particular at step (c). For example, it may be a diluent which is intended to be present in a lubricating composition comprising the polymer or the oligomer obtained by a process according to the invention. Preferably, the diluent is an ester lubricant, in particular the ester lubricant that is introduced into the reactor at step (a).

In one embodiment, the at least one diphenylamine and/or the at least one phenyl α-naphthylamine are introduced into the reactor in the form of a solution in the ester lubricant. In one embodiment, the solution comprising the at least one diphenylamine and/or the at least one phenyl α-naphthylamine does not comprise any diluent other than the ester lubricant. Preferably, the at least one diphenylamine and/or the at least one phenyl α-naphthylamine is in the form of a solution in the ester lubricant in an amount from 40 to 80% by weight. In particular, the at least one diphenylamine and/or the at least one phenyl α-naphthylamine is in the form of a solution at about 60% by weight in the ester lubricant. In a particular embodiment, the at least one diphenylamine and the at least one phenyl α-naphthylamine are introduced into the reactor in the form of a solution in the ester lubricant, comprising the at least one diphenylamine and the at least one phenyl α-naphthylamine.

The reagents are introduced into the reactor at step (a) of the process according to the invention in the absence of solvent. By “solvent”, reference is made according to the present invention to a compound in which at least one of the reagents could be at least partially dissolved and/or dispersed, which does not react under the reaction conditions, and which is intended to be eliminated or separated from the polymer or oligomer obtained at the end of the reaction. A solvent differs from a diluent at least in that its boiling point is generally lower than 250° C., which enables separation thereof from the obtained polymer or oligomer by evaporation at the end of the reaction.

By “in the absence of solvent”, reference is made in the present invention to conditions under which the considered solution comprises less than 20% by weight of solvent, preferably less than 10% by weight of solvent, in particular less than 5% by weight of solvent, in particular less than 1% by weight of solvent.

By diphenylamine or phenyl α-naphthylamine “repeat unit”, it should be understood the fact that, in the final structure of the oligomer or of the polymer obtained according to the invention, is present at least one, preferably at least two, diphenylamine or phenyl α-naphthylamine unit(s) respectively.

The diphenylamine and phenyl α-naphthylamine repeat units may be positioned in any way with respect to each other in the structure of the polymer or of the oligomer obtained according to the invention. Thus, the polymer or the oligomer may comprise, at least over a portion of its structure, a regular alternation of diphenylamine and phenyl α-naphthylamine repeat units. It may comprise, at least over a portion of its structure, a random distribution of diphenylamine and phenyl α-naphthylamine repeat units. Finally, it may comprise, over at least one portion of its structure, a block comprising a single type of diphenylamine or phenyl α-naphthylamine repeat unit.

In one embodiment, the polymer and/or oligomer obtained by the process according to the invention comprises only diphenylamine and phenyl α-naphthylamine repeat units in its structure. In another embodiment, the polymer and/or oligomer obtained by the process according to the invention comprise(s) only diphenylamine repeat units in its/their structure.

By “organic peroxide”, reference is made in the present invention to any organic compound comprising two oxygen atoms bonded together by a single covalent bond. Preferably, it is a compound of formula (III):

R₂₃—O—R₂₄ (III)

wherein R23 and R24 are an alkyl group independently of each other.

In some embodiments, R23 and R24 are identical. For example, it may consist of di-tert-butyl peroxide. The organic peroxide is an initiator of the polymerisation and/or the oligomerisation of the different repeat units. The organic peroxide may be present in the reactor in any suitable proportion with respect to the other reagents, in particular with respect to the at least one diphenylamine, to the at least one phenyl α-naphthylamine, and to the ester lubricant. For example, the organic peroxide may be present in a proportion from 10 to 50% by weight with respect to the total mass of the organic peroxide, the amount will be adjusted according to the desired average molecular mass and viscosity of the polymer, of the at least one diphenylamine, of the at least one phenyl α-naphthylamine and of the ester lubricant and the amount of peroxide lost during the reaction. Preferably, the organic peroxide is liquid under the reaction conditions. Preferably, the peroxide is volatile to enable the elimination at the end of the reaction of the residual peroxide where necessary.

The organic peroxide may be introduced into the reactor either pure or diluted in a diluent. Preferably, the diluent is an ester lubricant, in particular the ester lubricant that is introduced into the reactor at step (a). In one embodiment, the organic peroxide solution does not comprise a solvent. Preferably, the organic peroxide is in the form of a solution in the ester lubricant in an amount of 30 to 70% by weight. In particular, the organic peroxide is in the form of a solution at about 50% by weight in the ester lubricant.

The organic peroxide may be introduced in an amount of 1.0 to 2.0 molar equivalents, preferably from 1.3 to 1.6 molar equivalents, with respect to the total amount of diphenylamine and phenyl α-naphthylamine.

By “ester lubricant”, reference is made in the present invention to any ester or mixture of esters having lubricating properties. Preferably, the polymer or the oligomer obtained upon completion of the process according to the present invention is intended to be used as an antioxidant agent in a lubricating composition comprising at least said ester lubricant. Preferably, the ester lubricant used according to the invention is saturated, i.e. it comprises no double or triple chemical bond apart from the C═O bond of each ester function. Among the ester lubricants that could be used in a process according to the invention, mention may be made of the monoesters of octyl acetate, of decyl acetate, of octadecyl acetate, of methyl myristate, of butyl stearate, as well as the polyesters of dibutyl phthalate, di-octyl adipate, bis-2-ethylhexyl azelate and bis-2-ethylhexyl sebacate. The polyol ester type lubricant may be prepared from technical pentaerythritol or trimethylol propane and a mixture of linear and/or branched carboxylic acids having from 4 to 18 carbon atoms, for example having 9 carbon atoms. The technical pentaerythritol is a mixture which comprises about 85% to 92% by weight of monopentaerythritol and 8% to 15% by weight of dipentaerythritol. A common commercial technical pentaerythritol contains about 88% by weight of monopentaerythritol and about 12% by weight of dipentaerythritol, with respect to the total weight of the ester lubricant. The technical pentaerythritol may also contain a certain amount of tri- and tetra-pentaerythritols which are commonly formed as by-products during the production of the technical pentaerythritol. In particular, the ester lubricant may be selected from the group consisting of trimethylolpropane tri-nonanoate and the esters prepared from pentaerythritol and from at least one branched carboxylic acid comprising 9 carbon atoms.

In one embodiment, the ester lubricant is linear. In another embodiment, the ester lubricant is branched. A person skilled in the art is able to select the ester lubricant to be used in the process according to the invention in particular according to the nature of the at least one diphenylamine, of the at least one phenyl α-naphthylamine, of the peroxide, of the properties desired for the solution of oligomer and/or polymer and ester lubricant to be prepared and/or of the field of use intended for the obtained solution of oligomer and/or polymer and ester lubricant.

The ester lubricant is introduced into the reactor in an amount suitable to obtain a desired mixture of the oligomer or polymer in the ester lubricant. For example, the solution drawn off from the reactor may comprise between 20 and 60% by weight, in particular between about 30 and 50% by weight, of the oligomer or of the polymer in the ester lubricant depending on the nature of the ester.

Steps (a) and (b) can be implemented in any reactor suitable for continuous implementation. In particular, it may consist of a reactor of the static mixer, disperser mixer, roll mill mixer, extruder or horizontal axis mixer type. In particular, it may consist of a continuous reactor of the G1 to G4 type as commercialised by Corning. In particular, the useful volume of the reactor may be comprised between 50 mL and 5 litres, preferably between 50 mL and 1 litre (and, for example, the Corning type reactor used in the examples hereinafter is suitable). A person skilled in the art is able to select the appropriate reactor according to the nature of the reagents, the reaction conditions, in particular the stay time, and the volume to be produced in particular.

In a particular embodiment, the reactor is a reactor of the G1 static mixer type with 10 fluidic modules. The system may further comprise two metering lines connected to the reactor, as well as at least one sensor and at least one temperature display. A back-pressure regulator and a device enabling the control of temperature may also be included in the system.

The pressure at the inlet of the reactor may be comprised between 1 and 20 bars. In particular, the pressure at the inlet of the reactor may be comprised between 5 and 20 bars, preferably between 15 and 19 bars, in particular for reactors in which all reagents are in the liquid phase. For example, these pressure ranges are suitable for the Corning type reactor used in the examples hereinafter. Indeed, the pressure at the inlet (as well as the back-pressure at the outlet) is a parameter that depends on the type of reactor used and which can therefore be modified according to the latter. In addition, the pressure is also inherent to the reaction temperature used during step (b) (an imposed parameter and not an adjustable parameter).

In the reactor, the reagents may in particular be in the liquid or gaseous phase. In some reactor types, all of the reagents are in the liquid phase, and, in this case, the pressure at the inlet of the reactor may be comprised between 5 and 20 bars, preferably between 15 and 19 bars. In other reactor types, part of the reagents are in the liquid phase and another part of the reagents are in the gaseous phase. In this case, the pressure at the inlet of the reactor may be lower and may be comprised between 1 and 20 bars.

Of course, step (a) may further comprise the introduction into the reactor of any other reagent, solvent or diluent necessary for the implementation of step (b) or of a subsequent step of the process.

Step (a) is carried out continuously, i.e. at least one of the reagents is introduced continuously into the reactor. The rate of introduction of each reagent into the reactor at step (a) may vary over time, preferably ensuring a constant inlet flow rate for all reagents.

By “reagent”, reference is made in the present invention to all of the compounds that are introduced into the reactor at step (a), in particular the at least one diphenylamine, the at least one phenyl α-naphthylamine, the at least one organic peroxide, and the at least one ester lubricant. In the case where a small proportion of solvent would be introduced into the reactor at step (a), the solvent is not one of the compounds referred to as “reactive”.

In one embodiment, the process according to the invention comprises, before step (a), a step (a1) of premixing at least two among the at least one diphenylamine, the at least one phenyl α-naphthylamine, the ester lubricant and the organic peroxide, to form a solution comprising them. Mixing of the reagents before introduction thereof into the reactor contributes in particular to minimising their stay time in the reactor, in particular when the solution comprising at least two among the at least one diphenylamine, the at least one phenyl α-naphthylamine, the ester lubricant and the organic peroxide is then subjected to a preheating step (a2) as described hereinafter.

In one embodiment, step (a1) is the premixing of the at least one diphenylamine and of the at least one phenyl α-naphthylamine, optionally in the presence of the ester lubricant. In one embodiment, step (a1) is the premixing of the at least one diphenylamine and of the organic peroxide, optionally in the presence of the ester lubricant. In one embodiment, step (a1) is the premixing of the at least one phenyl α-naphthylamine and of the organic peroxide, optionally in the presence of the ester lubricant. In a preferred embodiment, step (a1) is the premixing of the at least one diphenylamine, of the at least one phenyl α-naphthylamine and of the organic peroxide, optionally in the presence of the ester lubricant.

In one embodiment, the process according to the invention comprises, before step (a), and where necessary after step (a1), a step (a2) of preheating the at least one diphenylamine, the at least one phenyl α-naphthylamine, the ester lubricant, the organic peroxide and/or the solution comprising at least two among these obtained at step (a1) at a temperature called “preheating temperature”. The preheating temperature is higher than room temperature, and lower than or equal to the temperature at which step (b) is implemented. In particular, the preheating temperature may be comprised between 40 and 100° C. In particular, such a preheating step contributes to minimising the stay time of the reagents in the reactor.

Steps (a1) and/or (a2) may be implemented independently of one another either continuously or discontinuously. Each of them may be implemented independently in a discontinuous reactor, or in a portion of the continuous reactor connected to the portion of the continuous reactor in which step (b) is implemented. Preferably, steps (a1) and (a2) are implemented continuously.

In the case where the process comprises a step (a1) of premixing and/or (a2) of preheating all or part of the reagents, the introduction of the reagents of step (a) is carried out by introducing into the reactor in particular premixed and/or preheated reagents obtained upon completion of step (a1) and/or (a2).

Step (b) may be implemented under any conditions suitable for carrying out the radical polymerisation or oligomerisation of the at least one diphenylamine, optionally of the at least one phenyl α-naphthylamine and of any other possible reagents to be polymerised or oligomerised.

The temperature of step (b) is higher than or equal to 170° C. Preferably, the temperature is actually at least sufficient to trigger the initiation of the reaction by the organic peroxide. Preferably, the temperature is comprised between 180° C. and 250° C., in particular between 180° C. and 230° C.

According to the invention, “a temperature comprised between 180° C. and 250° C.” comprises the following values and any interval comprised between these values: 180; 185; 190; 195; 200; 205; 210; 215; 220; 225; 230; 235; 240; 245; 250.

According to the indications of the continuous reactor manufacturers and in a usual way, in order to transpose a chemical synthesis from a discontinuous (batch) mode to a continuous mode, it is recommended to lower the reaction temperature compared to that commonly used for carrying out the reaction (namely herein, lower the temperature to a value below 160° C.). Indeed, in particular thanks to its particular geometry and to the pressure exerted within the reactor (reaction forced by the pressure), the continuous reactor allows obtaining a better quality of mixing and contacts between the reagents of the starting components and considerably improving contact thereof thereby making useless the use of a reaction temperature that is high or identical to that commonly used during a discontinuous process.

However, the Applicant has discovered that, on the contrary and surprisingly and unexpectedly, the temperature used in batch mode, namely 150-160° C., does not lead to any reaction in continuous mode, unless the reaction temperature is increased beyond the usual reaction temperature (i.e. : 160° C.), it has been possible to synthesise continuously and adequately (triggering of the polymerisation and polymerisation reaction with good yield) an oligomer and/or polymer comprising at least one diphenylamine repeat unit and optionally at least one phenyl α-naphthylamine unit (cf. the comparative embodiments and the embodiments according to the invention hereinafter).

Without being bound by any theory, it seems that this unexpected phenomenon (increase in temperature instead of reduction thereof) is related to the fact that the limiting reaction of the chemical synthesis is not the polymerisation itself, but the dissociation of the peroxide into a radical. This last reaction is reversible monomolecular and thus, in order to shift the equilibrium of the reaction towards the oligomer and/or polymer synthesis (i.e. : to shift the equilibrium to the right), the reaction temperature should be raised beyond that commonly used (the pressure within the reactor would probably lead to the recombination of the radicals into starting peroxide, namely, the pressure would favour the reverse reaction).

Step (b) may be implemented in the presence of a back-pressure (at the outlet), in particular to keep all of the compounds present in the reactor, in particular the alcohol produced following the degradation of the organic peroxide, in liquid form. In particular, the back-pressure may be comprised between 3 and 20 bars, in particular comprised between 10 and 16 bars. According to the invention, “a pressure comprised between 3 and 20 bars” includes the following values and any interval comprised between these values: 3; 4; 5; 6; 7; 8; 9; 10; 11; 12; 13; 14; 16; 17; 18; 19; 20.

In general, step (b) is performed at a temperature ranging from 180° C. to 230° C., in particular from 190° C. to 220° C., and at a pressure (inlet pressure and outlet back-pressure) from to 16 bar, or from 15 to 20 bar.

The stay time of the reagents in the reactor can be adapted by a person skilled in the art in particular according to the temperature/pressure pair, the inlet flow rate of each reagent and the nature of the reagents. In general, the stay time of the reagents in the reactor is less than 10 minutes, preferably less than 5 minutes. In particular, the stay time of the reagents in the reactor may be comprised between 1 minute and 5 minutes, and optionally between 0 and 1 minute. A stay time of the reagents that is too long could lead to substantial pressure drop problems, related in particular to the length of the channels and the number of baffles and obstacles, but also to a Gardner colour of the sample that is too high compared to the requirements in certain fields of application, in particular oils for the automotive or aeronautical industry.

The Gardner colour scale is a scale for visual comparison of the colour of clear and transparent liquids. It comprises 18 levels numbered from 1 to 18 ranging from pale yellow (Gardner colour 1) to dark brown (Gardner colour 18). The colours intensify from level 1 up to level 18. However, light shades range from level 1 to level 11, whereas darker shades range from level 12 to 18. In particular, the levels of this Gardner colour scale may correspond to the following colours:
scales 1 to 4: very pale yellow to pale yellow colour;
scales 5 to 10: pale yellow colour to yellow colour;
scale 11 to 12: more intense yellow colour to orange-yellow colour;
scale 13-14: more intense orange-yellow colour to orange colour;
scale 15-16: more intense orange colour to orange/red colour;
scale 17: brown-red colour;
scale 18: brown colour.

The continuous process according to the invention allows obtaining oligomers and/or polymers having a relatively modest Gardner colour, in particular when they are in solution in the ester lubricant. The Gardner colour of an oligomer and/or polymer obtained according to the invention in solution at 1.5% by weight in the ester lubricant is in particular lower than or equal to 12, preferably comprised between 9 and 11. The continuous process according to the invention allows for good repeatability of these Gardner colour values, in particular better than that obtained when implementing such a process in discontinuous mode. As mentioned hereinabove, a Gardner colour level ranging from 9 to 11 after dilution of the lubricant in the base oil still corresponds to a light colour suitable for the field of lubricants and in particular lubricants for the aeronautical or automotive industry.

Preferably, step (b) is followed by a step (b1) of drawing off, from the reactor, at least one oligomer or polymer of diphenylamine and optionally at least one phenyl α-naphthylamine, preferably in solution in the ester lubricant. Preferably, the draw-off flow rate is equal to the inlet flow rate of the reagents of step (a).

Step (c) comprises subjecting the reaction mixture obtained at step (b), optionally drawn off at step (b1), and optionally cooled in a step (d) as described hereinafter, to conditions suitable for eliminating at least part of the residual reagents and/or reaction by-products other than the oligomers or polymers comprising at least one diphenylamine unit and optionally at least one phenyl α-naphthylamine unit. The conditions of implementation of step (c) can vary to a large extent, and can be adapted by a person skilled in the art in particular according to the compounds to be eliminated, the used reactor and/or the conditions of implementation of step (b). In the context of the present step (c), the term “eliminate” a compound and its variations refer to the separation of said compound from the oligomers or polymers comprising at least one diphenylamine unit and optionally at least one phenyl α-naphthylamine unit. In particular, the elimination may be implemented by evaporation or by distillation.

Among the residual reagents and/or reaction by-products that might be eliminated during step (c), mention may be made in particular of the residual organic peroxide, the at least one residual diphenylamine, the at least one phenyl residual α-naphthylamine and the at least one alcohol resulting from the decomposition of the organic peroxide. In particular, the at least one alcohol resulting from the decomposition of the organic peroxide may be tert-butanol, when the organic peroxide is di-tert-butyl peroxide. In this case, step (c) comprises a step of elimination, preferably by evaporation, of the tert-butanol.

In particular, step (c) may be implemented by evaporation of at least part of the residual reagents and/or of the reaction by-products other than the oligomers or polymers comprising at least one diphenylamine unit and optionally at least one phenyl α-naphthylamine unit. The evaporation may be implemented in different ways. In some embodiments, the evaporation is implemented by decompression of at least one portion of the reactor in which step (b) has been implemented, the decompression leading to the evaporation of all or part of said compound(s) to be eliminated. Alternatively or cumulatively, the evaporation may be implemented by vacuum evaporation, preferably after cooling as detailed in step (d) hereinafter, of the mixture obtained upon completion of step (b) or (d).

Step (c) may be implemented either continuously, at the outlet of the reactor or part of the reactor in which step (b) has been implemented, or discontinuously in a distinct reactor. For example, the reactor in which step (c) is implemented may be a column evaporator.

Step (c) may also be followed or preceded by a step (d) of cooling the at least one oligomer or polymer obtained upon completion of step (b), for example drawn off at step (b1), at a temperature called “cooling temperature”. The cooling temperature is lower than the temperature at which step (b) is implemented, and higher than or equal to room temperature. In particular, the cooling temperature may be comprised between 50° C. and 90° C., in particular it may be around 70° C.

In particular, the continuous process according to the invention features a reduced cycle time, an improvement in the quality of the obtained oligomer or polymer, in particular of its colour, a low variability of the technical characteristics such as the colour and/or the polydispersity of the polymer or oligomer, increased safety, environmental advantages, simplified maintenance, space saving and comfort of use compared to the discontinuous processes known in the art.

In terms of cycle time, the reaction time is generally in the range of a few minutes, whereas for discontinuous processes the reaction time for a similar oligomerisation or polymerisation is generally in the range of 8 to 15 hours per cycle on an industrial scale. In particular, this allows for a considerable gain in terms of production capacity.

In terms of product quality, the oligomer or polymer of at least one diphenylamine and at least one phenyl α-naphthylamine obtained upon completion of the process according to the invention has a satisfactory colouring which may be weaker than that obtained by discontinuous processes. In a batch system, the colour variations are greatly enlarged compared to a continuous system. A variation of 4 Gardner points could be counted from one batch to another starting from the same operating conditions. In a continuous system as is the case in the present invention, the variation is less than 1 Gardner, and preferably less than 0.5 G. In the field of high-performance lubricants such as automotive lubricants, the colouring of lubricants and additives such as antioxidants is a real concern to the extent that a less coloured lubricant suggests a cleaner, newer lubricant and is therefore considered as a sign of quality.

Furthermore, the process according to the invention allows obtaining constant performance and good repeatability, and thus control of parameters such as the molar masses of the obtained oligomers and polymers, their polydispersity and/or the level of oligomer or polymer in the ester lubricant.

In terms of safety, the volume of the reactor being relatively small, the dangerousness of the reaction is greatly reduced, in particular if one considers the particular risk related to the use of an exothermic oxidation/radical polymerisation reaction, compared to an implementation in discontinuous form. This element is an undeniable asset of the process according to the invention since the oxidation and polymerisation reaction is the first source of industrial accident in the chemistry field.

In environmental terms, the losses of reagents such as peroxides are significantly reduced compared to discontinuous processes, which leads to a reduction in wastes and effluents. For comparison, the loss of unreacted alkyl peroxide, for example di-tert-butyl peroxide, in a batch process conventionally operated between 140 and 170° C. is at least 50%. The continuous process according to the invention allows drastically reducing these organic peroxide wastes compared to the discontinuous process, since values ranging up to less than 10% of unreacted peroxide can be reached. In an embodiment according to the invention, at least 90% of the organic peroxide, preferably at least 95%, in particular at least 99%, reacts during the reaction at step (b). Industrially, the reduction in the amount of residual peroxide at the end of step (b) allows in particular a reduction in the chemical risk related to the management of hazardous effluents, since the peroxides are explosive under some conditions, in particular over long storage times in the presence of other reagents or volatile impurities. A low, and even zero, concentration of organic peroxide within and at the outlet of the reactor is a guarantee of improved safety at the plant level and ease of elimination of wastes related to effluents.

Finally, advantages in terms of energy consumption, simplified maintenance, space saving and comfort of use are also provided by the continuous process according to the invention compared to discontinuous processes.

The present invention also relates to an oligomer and/or polymer comprising at least one diphenylamine repeat unit and optionally at least one phenyl α-naphthylamine repeat unit that could be obtained, in particular obtained, by a process according to the invention. Advantageously, the oligomer and/or polymer comprising at least one diphenylamine repeat unit and optionally at least one phenyl α-naphthylamine repeat unit that could be obtained, in particular obtained, by a process according to the invention is in solution in the ester lubricant.

In the present invention, any range or any interval defined by limits should be understood limits included, unless stated otherwise.

Unless stated otherwise, the percentages indicated in the present application are percentages by weight.

By “room temperature”, in the present invention, it should be understood a temperature of about 25° C.

In the present invention, the term “about” a value V refers to an interval comprised between 0.9xV and 1.1xV. In some embodiments, it refers to an interval comprised between 0.95xV and 1.05xV, in particular an interval comprised between 0.99xV and 1.01xV.

### Examples

The different tests have been implemented with the following raw materials:
mixture of diphenylamines: mixture of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine known under the name Irganox® L57 and CAS number 68411-46-1,
phenyl α-naphthylamine: N-phenyl 1,1,3,3-tetramethylbutylnaphthalen 1-amine
organic peroxide: di-tert-butyl peroxide,
introduction of the amines as a mixture in the form of a solution at 60% by weight in tri-nonanoate of trimethylol propane,
introduction of organic peroxide in the form of a 50% mass solution in trimethylol propane tri-nonanoate.

### Comparative Example 1 According to the Discontinuous Process of the Prior Art

For this comparative test, the Applicant has replicated Example 2 of the patent EP 0 734 432 from the raw materials listed hereinabove.

In particular, the experimental conditions of the discontinuous process, as well as the characteristics of the final product are summarised in Table I hereinbelow:

TABLE 1
Table I

| | | Comp. Ex. |
|---|---|---|
| Parameters | Unit | (batch) |
| Bath temperature | ° C. | 160 |
| Time of introduction of the di-tert-butyl | h | 3 h 30 |
| peroxide | | |
| Unreacted di-tert-butyl peroxide proportion | % | 65 |
| Characteristics of the formed product | | |
| Min Gardner colour | — | 9.8 |
| Max Gardner colour | — | 13.8 |
| Residual (unreacted) monomer content | % | 4 |
| | (w/w copolymers) | |

The amount of unreacted peroxide has been measured in the distillate. The Gardner colour has been measured on samples at 0.75% active matter (aminic polymers) by weight in trimethylol propane tri-monoate using a spectrometer (ASTM D 6166-12 method).

This comparative test 1 has been repeated three times. As shown in Table I hereinabove, the process according to the prior art has an unreacted peroxide content in the range of 65%. This high unreacted peroxide content represents a definite disadvantage on the one hand, from an economic point of view (loss of raw materials), and on the other hand, from a safety point of view to the extent that the storage and destruction of the effluent comprising the peroxide is complicated. In addition, the process of the prior art does not allow obtaining a final product having constant characteristics, in particular in terms of colour. The sample resulting from the discontinuous process according to the prior art does not have a constant colour, the latter can vary from 9.8 to 13.8 on the Gardner scale. Yet, a 13.8 colour corresponds to a dark brown colour not suitable for the automotive and/or aeronautical field.

### Examples According to the Continuous Process According to the Invention and Comparative Examples (Continuous Process, Reaction T°<170° C.)

Several samples 1 to 8 have been produced by implementing a process according to the invention in a Corning® Advanced-FIow™ glass type G1 reactor with Therminol fluid (supplied by Total) as heat-transfer fluid.

The used raw materials are the same as those mentioned hereinabove. The conditions for implementing the reactions are summarised in Table 1 hereinbelow. In particular, the cooling temperature is 70° C.

Comparative Examples 2 to 7 have also been performed according to a continuous process starting from the same raw materials and following substantially the same procedure, except the temperature during the polymerisation step.

TABLE 2

| | Reactor | Peroxide | Amine | Peroxide | Stay | Back- | Inlet |
|---|---|---|---|---|---|---|---|
| | temperature | flow rate | flow rate | molar | time | pressure | pressure |
| Sample | (° C.) | (mL/min) | (mL/min) | equivalents | (min) | (bar) | (bar) |
| Comp. Ex. 2 | 100 | 12 | 17.5 | 1 | 0.34 | 5 | — |
| Comp. Ex. 3 | 110 | 12 | 17.5 | 1 | 0.34 | 5 | |
| Comp. Ex. 4 | 120 | 12 | 17.5 | 1 | 0.34 | 5 | |
| Comp. Ex. 5 | 130 | 12 | 17.5 | 1 | 0.34 | 5 | |
| Comp. Ex. 6 | 140 | 12 | 17.5 | 1 | 0.34 | 5 | |
| Comp. Ex. 7 | 150 | 14.3 | 15.7 | 1.3 | 0.33 | 5 | |
| 1 | 180 | 14.3 | 15.7 | 1.3 | 2.00 | 10 | 5 |
| 2 | 180 | 16.4 | 13.6 | 1.6 | 2.00 | 10 | 5 |
| 3 | 190 | 14.3 | 15.7 | 1.3 | 2.00 | 10 | 15 |
| 4 | 190 | 16.4 | 13.6 | 1.6 | 2.0 | 15 | 16 |
| 5 | 200 | 14.3 | 15.7 | 1.3 | 2.0 | 15 | 17 |
| 6 | 200 | 16.2 | 23.6 | 1.3 | 2.01 | 16 | 19 |
| 7 | 200 | 12 | 17.5 | 1.3 | 2.71 | 16 | 18 |
| 8 | 200 | 24 | 35 | 1.3 | 1.36 | 15.5 | 19.5 |

The results obtained in terms of percentage of residual monomers, unreacted peroxide and Gardner colour for each of the four samples are reported in Table 3 hereinbelow.

The Gardner colour has been measured on a sample at 1.5% by weight in trimethylol propane tri-nonanoate using a spectrophotometer, in particular according to the method described in the standard ASTM D6166-12 or ASTM D 1544. The colour has been determined while considering that there is no loss of peroxide or alcohol during the continuous reaction.

The percentage of residual monomers is a mass percentage, which has been determined by gas-phase (GC) and supercritical (SFC) chromatography.

The percentage of unreacted peroxide has been determined by gas-phase chromatography.

TABLE 3

| | Residual | Unreacted | Gardner | |
|---|---|---|---|---|
| Sample | monomer % | peroxide % | colour | Reaction |
| Comp. Ex. 2 | 100 | — | — | No |
| Comp. Ex. 3 | 100 | — | — | No |
| Comp. Ex. 4 | 100 | — | — | No |
| Comp. Ex. 5 | 100 | — | — | No |
| Comp. Ex. 6 | 100 | — | — | No |
| Comp. Ex. 7 | 100 | — | — | No |
| Ex. 1 | 45.5 | 61 | 5.1 | Yes |
| Ex. 2 | 25 | 88 | 5.9 | Yes |
| Ex. 3 | 4.40 | 37 | 10.1 | Yes |
| Ex. 4 | 1.85 | 40 | 9.9 | Yes |
| Ex. 5 | 4.70 | 10 | 10.9 | Yes |
| Ex. 6 | 1.9 | 6 | 10.8 | Yes |
| Ex. 7 | 2.5 | 2 | 10.9 | Yes |
| Ex. 8 | 3.2 | 15 | 10.6 | Yes |

Thus, the continuous process according to the invention allows obtaining oligomers of diphenylamine and of phenyl α-naphthylamine, in a few minutes, comprising less than 45.5% of residual monomers and having a light Gardner colour which is perfectly suitable for lubricants, in particular those intended for the aeronautical and/or automotive industries. In particular, a reaction temperature of 180° C. allows obtaining results that are at least similar in terms of % of unreacted peroxide and % of residual monomers compared to Comparative Example 1 according to the discontinuous process of the prior art. However, the Gardner colour of the final product is much lighter (Gardner colour of 5.1/5.9 for Examples 1 and 2 at 180° C. against a Gardner colour of 13.8 for Comparative Example 1). Furthermore, when the reaction temperature is increased to at least 190° C., the continuous process according to the invention allows obtaining oligomers of diphenylamine and of phenyl α-naphthylamine, in a few minutes, comprising less than 5% of residual monomers while having a light Gardner colour (in the range of 10). The characteristics of the formed product are also constant (constant Garder colour). Furthermore, the minimum reaction temperature during step (b) (170° C.) may also be obtained with other continuous type reactors capable of implementing mixed mixtures composed of gaseous and liquid substances at lower pressures.

The process is implemented in the absence of solvent, directly in the ester lubricant in which the diphenylamines, the phenyl α-naphthylamine and the organic peroxide are dissolved.

Of course, various other modifications may be made to the invention within the scope of the appended claims.

1.-13. (canceled)

14. A process for preparing at least one oligomer and/or polymer comprising at least one diphenylamine repeat unit and optionally at least one phenyl α-naphthylamine repeat unit, comprising the following steps:
(a) the introduction into a suitable reactor of:
at least one diphenylamine,
optionally at least one phenyl α-naphthylamine,
at least one organic peroxide, and
at least one ester lubricant;
(b) the polymerisation or oligomerisation of diphenylamine and optionally of phenyl α-naphthylamine to obtain a mixture comprising at least one oligomer or a polymer comprising at least one diphenylamine unit and optionally at least one phenyl α-naphthylamine unit, and
(c) subjecting the mixture obtained at step (b) to conditions suitable for reducing and/or eliminating at least part of the residual reagents and/or reaction by-products other than the oligomers or polymers comprising at least one diphenylamine unit and optionally at least one phenyl α-naphthylamine unit,
wherein steps (a) and (b) are implemented continuously and wherein step (b) is carried out at a temperature equal to or higher than 170° C.

15. The process according to claim 14, wherein step (b) is carried out at a temperature ranging from 180° C. to 250° C.

16. The process according to claim 15, wherein step (b) is carried out at a temperature ranging from 180° C. to 230° C.

17. The process according to claim 14, wherein the at least one diphenylamine is selected from the group consisting of N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine, N-(p-tert-butylphenyl)-N-(p-tert-octylphenyl)amine and any mixture thereof.

18. The process according to claim 14, wherein the phenyl α-naphthylamine is N-phenyl 1,1,3,3-tetramethylbutylnaphthalen 1-amine.

19. The process according to claim 14, wherein the polymer and/or oligomer obtained by the process according to the invention comprises in its structure only diphenylamine and phenyl α-naphthylamine repeat units.

20. The process according to claim 14, wherein the at least one diphenylamine and/or the at least one phenyl α-naphthylamine are introduced into the reactor in the form of a solution in the ester lubricant.

21. The process according to claim 14, wherein the organic peroxide is di-tert-butyl peroxide.

22. The process according to claim 14, wherein the ester lubricant is selected from the group consisting of trimethylolpropane tri-nonanoate and esters prepared from pentaerythritol and at least one branched carboxylic acid comprising 9 carbon atoms.

23. The process according to claim 14, wherein the process comprises, before step (a), a step (a1) of premixing at least two among the at least one diphenylamine, the at least one phenyl α-naphthylamine, the ester lubricant and the organic peroxide, to form a solution comprising them.

24. The process according to claim 14, wherein the process comprises, before step (a), a step (a2) of preheating the at least one diphenylamine, the at least one phenyl α-naphthylamine, ester lubricant, organic peroxide and/or a solution comprising at least two among these at a temperature higher than room temperature and lower than or equal to the temperature at which step (b) is implemented.

25. The process according to claim 14, wherein step (c) is followed or preceded by a step (d) of cooling the at least one oligomer or polymer of diphenylamine and optionally at least one phenyl α-naphthylamine obtained upon completion of step (b) at a temperature lower than the temperature at which step (b) is implemented, and higher than or equal to room temperature.

26. The process according to claim 14, wherein the mixture obtained at step (b) comprises an unreacted peroxide content lower than or equal to 60%, preferably lower than or equal to 45% and typically lower than or equal to 40%, the peroxide content being determined by gas-phase chromatography.

27. The process according to claim 26, wherein the mixture obtained at step (b) comprises an unreacted peroxide content lower than or equal to 45%, the peroxide content being determined by gas-phase chromatography.

28. The process according to claim 27, wherein the mixture obtained at step (b) comprises an unreacted peroxide content lower than or equal to 40%, the peroxide content being determined by gas-phase chromatography.

29. The process according to claim 14, wherein the mixture obtained at step (b) comprises a residual monomer content lower than or equal to 25%, the residual monomer content is a mass percentage determined by gas-phase (GC) and supercritical (SFC) chromatography.

30. The process according to claim 29, wherein the mixture obtained at step (b) comprises a residual monomer content lower than or equal to 10%, the residual monomer content is a mass percentage determined by gas-phase (GC) and supercritical (SFC) chromatography.

31. The process according to claim 30, wherein the mixture obtained at step (b) comprises a residual monomer content lower than or equal to 5%, the residual monomer content is a mass percentage determined by gas-phase (GC) and supercritical (SFC) chromatography.
